(19) United States
(12) Patent Application Publication
(10) Pub. No.: US 2020/0190670 A1
(43) Pub. Date: Jun. 18, 2020

(54) NANO METAL FILM DEPOSITION

(71) Applicant: AVERATEK CORPORATION, Santa Clara, CA (US)

(72) Inventors: Sunity K SHARMA, Fremont, CA (US); Calvin CHEN, Daly City, CA (US); Shinichi IKETANI, Sunnyvale, CA (US); Michael Riley VINSON, Sunnyvale, CA (US)

(21) Appl. No.: 16/714,036

(22) Filed: Dec. 13, 2019

Related U.S. Application Data
(60) Provisional application No. 62/779,209, filed on Dec. 13, 2018.

(51) Int. Cl. C23C 18/44; C09D 11/037; C09D 11/033; C23C 18/40

(52) U.S. Cl. CPC C23C 18/44; C23C 18/40; C09D 11/033; C09D 11/037

(57) ABSTRACT

Devices, systems, and methods are contemplated for depositing metals to the surface of a substrate. A first precursor ink including a metal is applied to a surface of the substrate, and the precursor ink is reduced to deposit the metal to the substrate, preferably by thermal reduction, forming a first metal layer. A second precursor ink having a second metal is then applied to the substrate, at least partially over the first metal layer. The second precursor ink is then reduced, typically by chemical reduction, depositing the second metal over the first metal layer in a globular fashion. Precursor inks are also disclosed having an alkyl metal carboxylate, a cyclic amine, and at least one of an ester, a hydrocarbon, or an ether.

This application claims the benefit of U.S. Provisional Patent No. 62/779,209, filed Dec. 13, 2018, which is incorporated by reference in its entirety herein.

### FIELD OF THE INVENTION

The field of the invention relates to methods and systems depositing metallic films.

### BACKGROUND

The following description includes information that may be useful in understanding the present invention. It is not an admission that any of the information provided herein is prior art or relevant to the presently claimed invention, or that any publication specifically or implicitly referenced is prior art.

The manufacture of electrical circuits (e.g., printed circuit board, etc) is a highly competitive field with constant innovation. For example, WO 2008/094494 to Wagner teaches depositing metal on substrate by using metal precursor, neutral labile ligands, and supercritical solvent. However, Wagner does not appear to provide for depositing two layers of different metals, for example mixtures of Pd and Pt, and does not provide that the layers be nano-scale thick.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Further, U.S. Pat. No. 5,894,038 to Sharma, et al, teaches depositing layers of Pd carboxylate precursor and reducing the precursor by heat. However, Sharma does not appear to provide depositing layers having multiple metal carboxylate precursors, for example mixtures of Pd and Pt, reducing such layers via chemical reduction, and that the layers are nano-scale.

Moreover, WO 2011/057218 to McCullough, et al, teaches depositing metal using metal complex that has two ligands, one of which is a carboxylate, and using heat to reduce the metal complex. McCullough also teaches mixtures of metals, but does not appear to teach specific blends of metals, sequentially depositing layers of different metals or different metal blends, or that such layers are nano-scale.

U.S. Pat. No. 7,695,760 to Kondo teaches depositing two layers of metal on a substrate by depositing an oxidized metal, adding a solution of conducting metal and a reducing agent, and reducing the oxidized metal to deposit the conducting metal. However, Kondo does not appear to provide for reducing metals or metal blends by heat to form a layer, and then reducing a second layer by chemical to form particles, or that the layer is nano-scale.

EP 3,296,428 to Bernhard teaches depositing two layers of metal onto a substrate, the first layer a metal oxide deposited by heat, and the second layer deposited on the first metal layer by chemical reduction. However, Bernhard does not appear to provide that the layers are metallic blends, that the layers are different metals, or that the layer is nano-scale.

Thus, there is still a need for improved methods and systems for manufacturing a depositing metals at nano-scale thickness.

### SUMMARY OF THE INVENTION

The inventive subject matter contemplates methods and systems for depositing metal on a substrate at a nano-scale thickness. A precursor ink having the metal is applied over at least a portion of the substrate, and at least a portion of the precursor ink is reduced on the substrate to deposit the metal on the substrate. The precursor ink includes (i) an alkyl metal carboxylate, (ii) an amine, and (iii) at least one of an ester, a hydrocarbon (e.g., saturated, partially unsaturated, unsaturated, substituted, unsubstituted, C₁₋₁₀ alkyl, alkenyl, alkynl, linear, branched, cyclic, etc) or an ether. The portion of the precursor ink that is reduced is reduced by heat (thermal reduction) or by chemistry (chemical reduction), though it is contemplated that self reducing precursor ink or electric reduction of the precursor ink can be used as an alternative or in combination thereof.

After the precursor ink is applied and the metal is deposited, a second precursor ink having a second metal can be applied over at least a portion of the deposited metal. At least a portion of the second precursor ink is then reduced on the deposited metal. The first precursor ink is typically different than the second precursor ink, for example the two precursor inks may have different metals, alloys, or combinations of metals. Preferably the precursor ink is reduced by a thermal reduction, and the second precursor is reduced by a chemical reduction. In some embodiments, the metal and the second metal are electroless plating catalysts. The second precursor ink generally has a second alkyl metal carboxylate, a second cyclic amine, and a second ester, and in some embodiments at least one of the first precursor ink and second precursor ink, the alkyl metal carboxylate and the second alkyl metal carboxylate, or the ester and the second ester are the same.

A precursor ink composition is further contemplated having an alkyl metal carboxylate, a cyclic amine, and an ester, a hydrocarbon, or an ether. The alkyl metal carboxylate has a C₁₋₇ alkyl, while the cyclic amine is selected from the group consisting of a substituted or unsubstituted (i) saturated C₃₋₆ amine, (ii) partially unsaturated C₃₋₆ amine, or (iii) fully unsaturated C₃₋₆ amine. The amine is preferably a cyclic amine. The ester is selected from the group consisting of R¹COOR², where R¹ is one of (i) hydrogen, (ii) substituted or unsubstituted C₁₋₆ alkyl, (iii) substituted or unsubstituted C₁₋₆ alkenyl, (iv) substituted or unsubstituted C₁₋₆ alkynyl, or (v) substituted or unsubstituted C₁₋₆ aryl. R² is typically one of (i) substituted or unsubstituted C₁₋₆ alkyl, (ii) substituted or unsubstituted C₁₋₆ alkenyl, (iii) substituted or unsubstituted C₁₋₆ alkynyl, or (iv) substituted or unsubstituted C₁₋₆ aryl. The alkyl metal carboxylate is at least one of Pt, Pd, Ag, Au, Cu, Ni, Co, Rh, In, Ir, Rh, Ru, W, Mo. Re, Os, or a mixture thereof. Preferably, the precursor ink is used to deposit a metal on a substrate, typically in a layer less than 500 nm thick.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A depicts a step in a process of the inventive subject matter.

FIG. 1B depicts a further step in a process of the inventive subject matter.

FIG. 1C depicts yet a further step in a process of the inventive subject matter.

FIG. 1D depicts still a further step in a process of the inventive subject matter.

### DETAILED DESCRIPTION

The present invention relates to methods, systems and devices for depositing one or two, or more, metals on a substrate. For example, the inventive subject matter contemplates methods and systems for depositing one or more metals on a substrate at a nano-scale thickness. A precursor ink having the metal is applied over at least a portion of the substrate, and at least a portion of the precursor ink is reduced on the substrate to deposit the metal on the substrate. The precursor ink includes (i) an alkyl metal carboxylate, (ii) an amine, and (iii) an ester, a hydrocarbon (e.g., saturated, partially unsaturated, unsaturated, substituted, unsubstituted, C₁₋₁₀ alkyl, alkenyl, alkynl, linear, branched, cyclic, etc) or an ether. The portion of the precursor ink that is reduced is reduced by heat (thermal reduction) or by chemistry (chemical reduction), though it is contemplated that self reducing precursor ink or electric reduction of the precursor ink can be used as an alternative or in combination thereof.

Preferably, the alkyl metal carboxylate has a C₁₋₇ alkyl and the metal. The metal is generally at least one of Pt, Pd, Ag, Au, Cu, Ni, Co, Rh, In, Ir, Ru, W, Mo. Re, Os, or mixtures thereof. In some embodiments, the metal deposited by the precursor ink includes an alloy or a mixture of one of Pd, Pt, Ag, Au, Cu, Ni, Co, Rh, In, Ir, Rh, Ru, W, Mo. Re, or Os.

The amine is generally selected from the group consisting of a substituted or unsubstituted (i) saturated C₃₋₆ amine, (ii) partially unsaturated C₃₋₆ amine, or (iii) fully unsaturated C₃₋₆ amine. The amines are used either as a pure amine or combination of two or more amines as described. The amine or amines are preferably cyclic amines. The solvent can be an ester, a hydrocarbon or an ether. Likewise, the ester is selected from the group consisting of R¹COOR², where R¹ is one of (i) hydrogen, (ii) substituted or unsubstituted C₁₋₆ alkyl, (iii) substituted or unsubstituted C₁₋₆ alkenyl, (iv) substituted or unsubstituted C₁₋₆ alkynyl, or (v) substituted or unsubstituted C₁₋₆ aryl. R² is generally one of (i) substituted or unsubstituted C₁₋₆ alkyl, (ii) substituted or unsubstituted C₁₋₆ alkenyl, (iii) substituted or unsubstituted C₁₋₆ alkynyl, or (iv) substituted or unsubstituted C₁₋₆ aryl.

In some embodiments, the precursor ink is reduced at least in part by one of dimethylamin borane (DMAB), amine borane (AB), hydrazine, formalin, hypophosphite salt, a complex metal hydride, an aldehyde, citric acid, or a carboxylic acid. Preferably, the metal is deposited in a layer less than 500 nm thick (e.g., less than 250 nm, 100 nm, 50 nm, 25 nm, 10 nm, 5 nm, 1 nm, 0.5 nm, 0.01 nm, 0.01 nm, etc), but can be deposited in layers up to 1 μm, 2 μm, or 3 μm.

After the first precursor ink is applied and the first metal is deposited, a second precursor ink having a second metal is applied over at least a portion of the deposited metal. At least a portion of the second precursor ink is reduced on the deposited metal. The first precursor ink is typically different than the second precursor ink, for example has different metals, alloys, or combinations of metals. Preferably the first precursor ink is reduced by a thermal reduction, and the second precursor is reduced by a chemical reduction. In some embodiments, the first metal and the second metal are electroless plating catalysts. The second precursor ink generally has a second alkyl metal carboxylate, a second cyclic amine, and a second ester, and in some embodiments at least one of the first precursor ink and second precursor ink, the first alkyl metal carboxylate and the second alkyl metal carboxylate, or the first ester and the second ester are the same.

A precursor ink composition is further contemplated having an alkyl metal carboxylate, a cyclic amine, and an ester, a hydrocarbon, or an ether. The alkyl metal carboxylate has a C₁₋₇ alkyl, while the cyclic amine is selected from the group consisting of a substituted or unsubstituted (i) saturated C₃₋₆ amine, (ii) partially unsaturated C₃₋₆ amine, or (iii) fully unsaturated C₃₋₆ amine. The amine is preferably a cyclic amine. The ester is selected from the group consisting of R¹COOR², where R¹ is one of (i) hydrogen, (ii) substituted or unsubstituted C₁₋₆ alkyl, (iii) substituted or unsubstituted C₁₋₆ alkenyl, (iv) substituted or unsubstituted C₁₋₆ alkynyl, or (v) substituted or unsubstituted C₁₋₆ aryl. R² is typically one of (i) substituted or unsubstituted C₁₋₆ alkyl, (ii) substituted or unsubstituted C₁₋₆ alkenyl, (iii) substituted or unsubstituted C₁₋₆ alkynyl, or (iv) substituted or unsubstituted C₁₋₆ aryl. The alkyl metal carboxylate is at least one of Pt, Pd, Ag, Au, Cu, Ni, Co, Rh, In, Ir, Rh, Ru, W, Mo. Re, Os, or a mixture thereof. Preferably, the precursor ink is used to deposit a metal on a substrate, typically in a layer less than 500 nm thick.

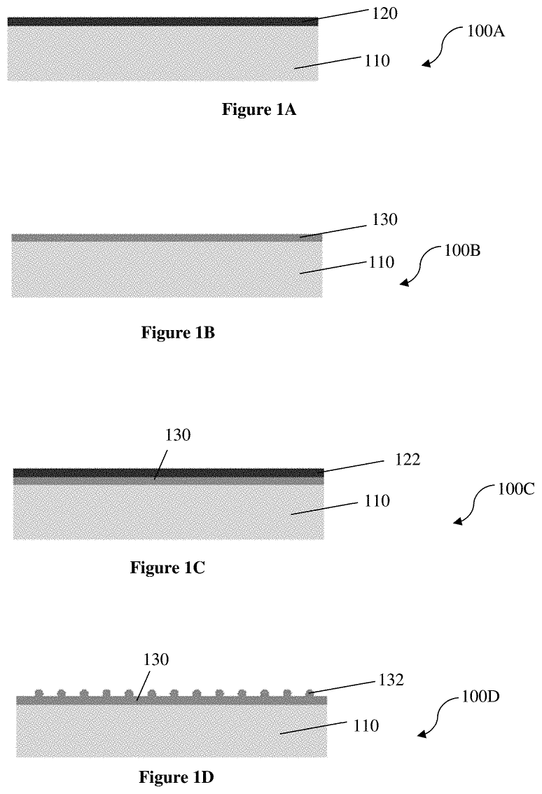

FIGS. 1A through 1D depict steps for depositing multiple metal layers. Configuration 100A in FIG. 1A depicts substrate 110 (e.g., dielectric material, polyimide, etc.) with precursor ink 120 (which includes one or more metals) applied to a surface of substrate 110. Precursor ink 120 is then reduced such that the metal is deposited over the surface of the substrate, preferably by thermal reduction, though chemical reduction is also contemplated. The metal is typically an alloy or a mixture of one of Pd, Pt, Ag, Au, Cu, Ni, Co, Rh, In, Ir, Rh, Ru, W, Mo. Re, or Os, preferably Pd or Pt.

FIG. 1B depicts configuration 100B, where precursor ink 120 has been reduced and metal layer 130 has been deposited on the surface of substrate 110. In this embodiment, precursor ink 120 was reduced by heat, yielding metal layer 130 as a cohesive, solid layer, though chemical reduction may alternatively or in combination be used, producing a globular deposit layer as depicted in FIG. 1D. Metal layer 130 can be composed or a single metal, a combination of different metals, or alloys as described above.

FIG. 1C depicts configuration 100C, which further includes precursor ink 122 applied over metal layer 130. Precursor ink 122 is subsequently reduced to deposit a further metal on the surface of metal layer 130.

FIG. 1D depicts configuration 100D, which further includes metal deposit 132 over metal layer 130. Metal deposit 132 is formed by the partial reduction of precursor ink 122, which forms metal deposit 132 as a globular shaped deposit along the surface of metal layer 130. It is contemplated that the precursor ink is reduced such that the globules have a typically radius of no more than the metal atomic radius, 1, 2, 3, 4, 5, 10, 15, 20, 30, 40, 500, 100, or 500 nm. The globules can further be deposited in a regular or irregular patter, or generally in the pattern of precursor ink 122, or of a chemical reducing agent applied to precursor ink 122. In the alternative, or in combination, thermal reduction can be used to deposit metal deposit 132 as a solid, cohesive layer, similar to metal layer 130. In some embodiments, precursor ink 120 and 122 can be the same, such that metal layer 130 and metal deposit 132 are the same, albeit deposited via different methods. However, it is also contemplated that precursor ink 120 and 122 different in some respects.

For example, precursor ink 120 and 122 can be the same except for the metal (e.g. metal carboxylate) component, such that metal layer 130 is made up of one metal (or alloy, or combination of metals), and metal deposit 132 is made up of another metal (or alloy, or combination of metals). For instance, in some embodiments metal layer 130 is a conductor (e.g., copper) while metal deposit is a catalyst (e.g., plating catalyst, Pd, Pt, etc). Thus, the inventive subject matter provides a method to deposit disparate metals over the surface of a substrate, for example conductors and catalysts, though it is also contemplated that the metal (e.g., metal carboxylate) in precursor inks 120 and 122 are of the same type (e.g., catalysts, conductors, etc) but carrying different metals, such that metal layer 130 and metal deposit 132 are different metals (e.g., gold and copper) but of the same type (e.g., conductors).

It should also be appreciated that using the deposition methods of the inventive subject matter, deposited metal layers (e.g., metal layer 130, metal deposit 132, etc) can be very thin. For example, metal layers formed by thermal or chemical reduction can form wide variation of thickness like less than lnm thick to several hundred nanometer in a process, with subsequent layers applied to add multiple layers of different metals with different deposit patterns (e.g., globular deposit, cohesive layer deposit, etc) or functions (e.g., conductor, catalyst, both, etc), or multiple layers of the same metals, with the same or different deposit patterns, to form the metal layer up to a desired thickness, for example sub nanometer, 1 nm, 5 nm, 10 nm, 25 nm, 50 nm, 100 nm, 250 nm, 500 nm, or more than 500 nm.

The discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A method for depositing a metal on a substrate, comprising:
applying a first precursor ink comprising the metal over at least a portion of the substrate; and
reducing at least a portion of the first precursor ink on the substrate to deposit the metal on the substrate, wherein the first precursor ink comprises an alkyl metal carboxylate, an amine, and a hydrophobic solvent.

2. The method of claim 1, wherein the hydrophobic solvent includes at least an ester, a hydrocarbon, an ether, or mixture of these.

3. The method of claim 1, wherein the portion of the first precursor ink is reduced by a thermal reaction or a chemical reaction.

4. The method of claim 1, wherein the alkyl metal carboxylate comprises the metal.

5. The method of claim 1, wherein the alkyl metal carboxylate comprises a C₁₋₇ alkyl.

6. The method of claim 1, wherein the metal is at least one of palladium, platinum, gold, silver, copper, nickel, cobalt, rhodium, ruthenium, iridium, tungsten, molybdenum, rhenium, osmium, an alloy or a mixture thereof.

7. The method of claim 1, wherein the metal of the alkyl metal carboxylate is at least one of palladium, platinum, gold, silver, copper, nickel, cobalt, rhodium, ruthenium, iridium, indium, tungsten, molybdenum, rhenium, osmium, or a mixture thereof.

8. The method of claim 1, wherein the amine is a primary amine.

9. The method of claim 8, wherein the primary amine is selected from the group consisting of a substituted or unsubstituted (i) saturated C₃₋₆ amine, (ii) partially unsaturated C₃₋₆ amine, or (iii) fully unsaturated C₃₋₆ amine.

10. The method of claim 8, wherein the primary amine is a cyclic amine.

11. The method of claim 1, wherein the ester is selected from the group consisting of R¹COOR², wherein
R¹ is one of hydrogen, substituted or unsubstituted C₁₋₆ alkyl, substituted or unsubstituted C₁₋₆ alkenyl, substituted or unsubstituted C₁₋₆ alkynyl, or substituted or unsubstituted C₁₋₆ aryl; and
R² is one of substituted or unsubstituted C₁₋₆ alkyl, substituted or unsubstituted C₁₋₆ alkenyl, substituted or unsubstituted C₁₋₆ alkynyl, or substituted or unsubstituted C₁₋₆ aryl.

12. The method of claim 1, wherein the portion of the first precursor ink is reduced by dimethylamine borane (DMAB), amine borane (AB), hydrazine, formalin, a complex metal hydride, a hypophosphite salt, an aldehyde, citric acid, or a carboxylic acid.

13. The method of claim 1, wherein the metal is deposited in a layer less than 500 nm thick.

14. The method of claim 1, further comprising the steps of:
applying a second precursor ink comprising a second metal over at least a portion of the deposited metal; and
reducing at least a portion of the second precursor ink on the portion of the deposited metal.

15. The method of claim 14, wherein the first precursor ink is different than the second precursor ink.

16. The method of claim 14, wherein the first precursor ink is reduced by a thermal reaction, and the second precursor is reduced by a chemical reaction.

17. The method of claim 14, wherein the metal, the second metal, or the metal and the second metal are electroless plating catalysts.

18. The method of claim 14, wherein the second precursor ink comprises a second alkyl metal carboxylate, a second amine, and a second hydrophobic solvent.

19. The method of claim 18, wherein at least one of the first precursor ink and second precursor ink, the alkyl metal carboxylate and the second alkyl metal carboxylate, or the hydrophobic solvent and the second hydrophobic solvent are the same.

20. A precursor ink composition comprising an alkyl metal carboxylate, an amine, and a hydrophobic solvent, wherein:
the alkyl metal carboxylate comprises a C₁₋₇ alkyl; and
the amine is selected from the group consisting of a substituted or unsubstituted (i) saturated C₃₋₆ amine, (ii) partially unsaturated C₃₋₆ amine, or (iii) fully unsaturated C₃₋₆ amine.

21. The composition of claim 20, wherein the hydrophobic solvent includes at least one of an ester, a hydrocarbon, an ether, or a mixture thereof.

22. The composition of claim 21, wherein the ester is selected from the group consisting of R¹COOR², wherein
R¹ is one of hydrogen, substituted or unsubstituted C₁₋₆ alkyl, substituted or unsubstituted C₁₋₆ alkenyl, substituted or unsubstituted C₁₋₆ alkynyl, or substituted or unsubstituted C₁₋₆ aryl; and
R² is one of substituted or unsubstituted C₁₋₆ alkyl, substituted or unsubstituted C₁₋₆ alkenyl, substituted or unsubstituted C₁₋₆ alkynyl, or substituted or unsubstituted C₁₋₆ aryl.

23. The composition of claim 20, wherein the amine is a cyclic amine.

24. The composition of claim 20, wherein the alkyl metal carboxylate is at least one of palladium, platinum, gold, silver, copper, nickel, cobalt, an alloy or a mixture thereof.

25. Use of the composition of claim 20 to deposit a metal on a substrate.

26. The use of claim 25, wherein the metal is deposited in a layer less than 500 nm thick.
